(19) United States
(12) Patent Application Publication
(10) Pub. No.: US 2012/0067603 A1
(43) Pub. Date: Mar. 22, 2012

(54) AXLE GUARD ASSEMBLY FOR COMPACTION MACHINE

(75) Inventor: Steven D. Springer, Aurora, IL (US)

(73) Assignee: CATERPILLAR INC., Peoria, IL (US)

(21) Appl. No.: 12/888,145

(22) Filed: Sep. 22, 2010

(51) Int. Cl. B62D 25/16; E02D 3/026; B60S 1/68

(52) U.S. Cl. 172/508; 305/107

(57) ABSTRACT

An axle guard assembly of a machine protects against intrusion of wire wrap into a central cavity of a ground engaging device. The guard, which is mounted to the axle, includes a wall disposed within the cavity of the ground engaging device. A cover can be provided which includes a flange circumscribing a central portion. The central portion is disposed axially inwardly of an inboard opening to the cavity. The flange can extend radially outwardly from the central portion and axially outwardly toward the wall. The periphery of the cover can be configured such that it is larger than the opening to the cavity. In another aspect, a support vane can be provided which extends along a longitudinal axis between a first wall and a second wall and includes a planar vane surface extending substantially radially to the longitudinal axis.

### TECHNICAL FIELD

This patent disclosure relates generally to compaction machines and, more particularly, to axle guard assemblies for compaction machines used to protect the axle and associated components from damage caused by entwined refuse and debris.

### BACKGROUND

In the operation of compaction machinery, especially the type known as a landfill compactor, it is quite common for the machine to traverse terrain that is covered with debris and refuse. In the case of a landfill compactor, the machine is driven over trash of all kinds to compact or compress it so that more trash may be deposited in the available volume afforded by the landfill site.

In operating a landfill compactor in that capacity, it is a common and vexatious problem to encounter the wrapping of wire, cable, hoses, textile material, long strips of plastic, and other strands of material around the wheels and axles of the landfill compactor. It is quite common for the teeth of the drum-type wheels to become attached to these strands of material as they roll over it. In doing so, the strands of material are caused to revolve with the wheel. As the movement of the machine continues, the strands can become wrapped around the axle. In some instances, the material becomes tightly wrapped around the axle. This debris, commonly referred to as “wire-wrap,” can migrate along the axle in the direction of the wheel into the internal cavity of the wheel which houses a rotational seal between the interface of the wheel and the axle.

When this material becomes wound around the axle, the winding action can force the strands into the seal interface. When this happens, the integrity of the seal can be compromised, thereby creating the need for immediate repair. The machine must be taken out of service to make the repair, which may include the replacement of several components. If operation of the machine continues without making the repair, one or more components of the drive assembly can be destroyed or negatively affected.

U.S. Pat. No. 7,731,307 is entitled, “Seal Guard for Compactor.” The '307 patent is directed to a guard for the axle seal of a wheeled tractor, which is an annular steel structure that bridges the plane of the seal between a spindle and final drive. The guard includes a pair of axially spaced flanges having circular outer peripheries, at least one of the outer peripheries of the flanges being sized to produce a narrow gap seal with a circular interior surface of a wheel rim, and a hub extending axially between the flanges and spaced radially inward of said flange outer peripheries. The flanges, hub and interior wheel surface define an annular space adapted to trap debris.

It will be appreciated that this background description has been created by the inventor to aid the reader, and is not to be taken as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a guard for an axle assembly of a machine. The guard includes a wall having a periphery and a cover disposed in spaced axial relationship to the wall. The cover includes a central portion and a flange, which circumscribes the central portion and extends radially outwardly therefrom and axially toward the wall. The flange includes an outer edge defining a periphery of the cover. The periphery of the wall is disposed radially within the periphery of the cover.

In another embodiment, a guard for an axle assembly of a machine includes a first wall, a second wall, and a support vane. The first wall and the second wall each includes a planar wall surface. The second wall is disposed in spaced relationship to the first wall along a longitudinal axis substantially perpendicular to the planar wall surfaces of the first wall and the second wall. The support vane extends between the first wall and the second wall. The support vane includes a planar vane surface extending substantially radially to the longitudinal axis.

In yet another embodiment, a machine is provided that includes a frame, a ground engaging device, an axle connected to the frame and supporting the ground engaging device, and a guard mounted to the axle. The ground engaging device includes a hub portion that defines a cavity and an inboard opening to the cavity. The guard includes a wall having a periphery and a cover disposed in spaced axial relationship to the wall. The wall is disposed within the cavity of the ground engaging device. The cover includes a central portion and a flange circumscribing the central portion. The central portion is disposed axially inwardly of the inboard opening to the cavity. The flange extends radially outwardly from the central portion and axially outwardly toward the wall. The flange of the cover includes an outer edge defining a periphery of the cover. The periphery of the wall is disposed radially within the periphery of the cover, and the periphery of the cover is larger than the opening to the cavity.

Further and alternative aspects and features of the disclosed principles will be appreciated from the following detailed description and the accompanying drawings. As will be appreciated, the guards for an axle assembly, the guard assemblies, and machines disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective view of an embodiment of a landfill compaction machine having a guard for an axle assembly in accordance with the disclosed principles.

FIG. 2 is an exploded view of a portion of an axle assembly for a landfill compaction machine as in FIG. 1.

FIG. 3 is an inboard elevational view of an embodiment of a guard for the axle assembly in accordance with the disclosed principles.

FIG. 4 is a cross-sectional view of the guard taken along line IV-IV in FIG. 3.

FIG. 5 is an outboard perspective view of the guard of FIG. 3.

FIG. 6 is a side elevational view of the guard of FIG. 3.

FIG. 7 is a fragmentary, cross-sectional view of the guard taken along line VII-VII in FIG. 6.

FIG. 8 is a cross-sectional view of the guard taken along line VIII-VIII in FIG. 6.

FIG. 9 is a perspective view of the portion of the axle assembly shown in FIG. 2.

FIG. 10 is a perspective view, partially in section, of the portion of the axle assembly as in FIG. 9.

FIG. 11 is an elevational view, partially in section, of the portion of the axle assembly as in FIG. 9.

FIG. 12 is an enlarged detail view taken from FIG. 11 as indicated by the box.

FIG. 13 is a plan view of an embodiment of a first cutting plan outline for a first set of components of the guard of FIG. 3.

FIG. 14 is a plan view of an embodiment of a second cutting plan outline for a second set of components of the guard of FIG. 3.

FIG. 15 is a perspective view of another embodiment of a guard for the axle assembly in accordance with the disclosed principles.

FIG. 16 is a perspective view of the guard of FIG. 15 taken from the other face thereof.

FIG. 17 is a side elevational view of the guard of FIG. 15.

FIG. 18 is a view as in FIG. 16 but with a first wall of the guard removed for illustrative purposes.

FIG. 19 is an end elevational view of the guard of FIG. 15.

### DETAILED DESCRIPTION

The present disclosure provides an axle guard assembly for any mobile machine having an axle and a final ground-engaging device, e.g., wheels, tracks, etc. Examples of such machines include machines used for compaction, mining, construction, farming, transportation, or any other industry known in the art. Moreover, one or more implements may be connected to the machine for a variety of tasks, including, for example, compacting, moving, loading, lifting, brushing, and include, for example, blades, buckets, compactors, forked lifting devices, brushes, grapples, cutters, shears, blades, breakers/hammers, augers, and others.

For example, in some embodiments, an axle guard assembly is provided that includes a guard arrangement for inhibiting the intrusion of wire wrap into and around components present at a joint between an axle and a wheel of a compaction machine. The guard can be advantageously effective in protecting components found at the axle joint, such as a sealed interface, for example, from wire wrap intrusion by impeding the ingress of wire wrap into a cavity of the wheel that encloses such components.

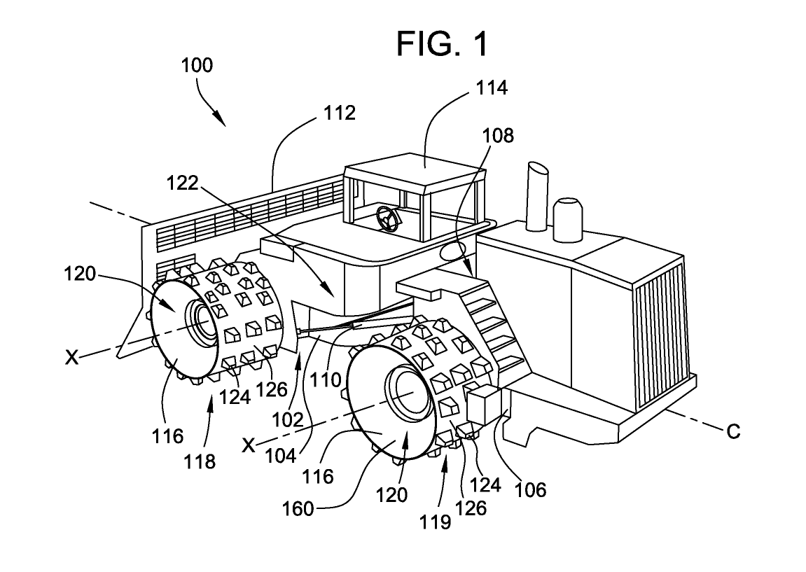

An exemplary embodiment of a machine 100 in the form of a landfill compactor is illustrated in FIG. 1. Referring to FIG. 1, the landfill compactor machine 100 includes a frame 102 including a forward portion or non-engine end 104 and a rearward portion or engine end 106. The engine end 106 and the non-engine end 104 of the frame 102 are connected to each other at a hitch or articulation joint 108. A pair of steering cylinders 110 (one shown) may be mounted between the non-engine end 104 and the engine end 106 of the frame 102 to provide steering.

A blade 112 is connected to the forward portion or non-engine end 104 of the frame 102. The non-engine end 104 of the frame 102 can also support an operator station or cab 114. The engine end 106 of the frame 102 can support, for example, a power source and cooling system components (not shown), the power source being operatively connected through a drive train (not shown) to drive at least one ground engaging device (such as, a plurality of wheels 116, as shown) for movement of the machine 100.

The frame 102 supports a front axle 118 and a rear axle 119. Other than their relative positions on the machine 100, the front axle 118 and the rear axle 119 are similar in construction. Each axle 118, 119 is positioned in transverse relation to a centerline “C” of the machine and extends laterally from opposite sides of the frame 102.

Each axle 118, 119 is connected to the frame 102 using any suitable technique. In some embodiments, the axle can be connected to the frame by being fixedly mounted to the frame, and in other embodiments the axle can be connected to the frame by being pivotally mounted to the frame to “oscillate” with respect thereto in response to changes to the terrain.

The front axle 118 and the rear axle 119 each has a pair of outboard ends 120 extending from both sides of the machine 100. The outboard ends on a right side of the machine (not shown) are similar in construction to the outboard ends 120 on a left side 122 of the machine (shown in FIG. 1).

Each outboard end 120 supports a ground engaging device in the form of a wheel 116 such that the machine 100 has four wheels 116. Each wheel 116 is mounted to its respective axle 118, 119 for rotation with respect thereto about an axis “X” which is generally perpendicular to the centerline “C” of the machine 100.

In the illustrated embodiment, each wheel 116 includes a plurality of teeth 124 positioned on an outer surface 126 of the wheel 116. The teeth 124 of a particular wheel 116 are in predetermined, spaced relationship to each other in a specific pattern across the outer surface 126 of the wheel 116 in a well known manner to provide sufficient compacting force to the ground or debris beneath each wheel.

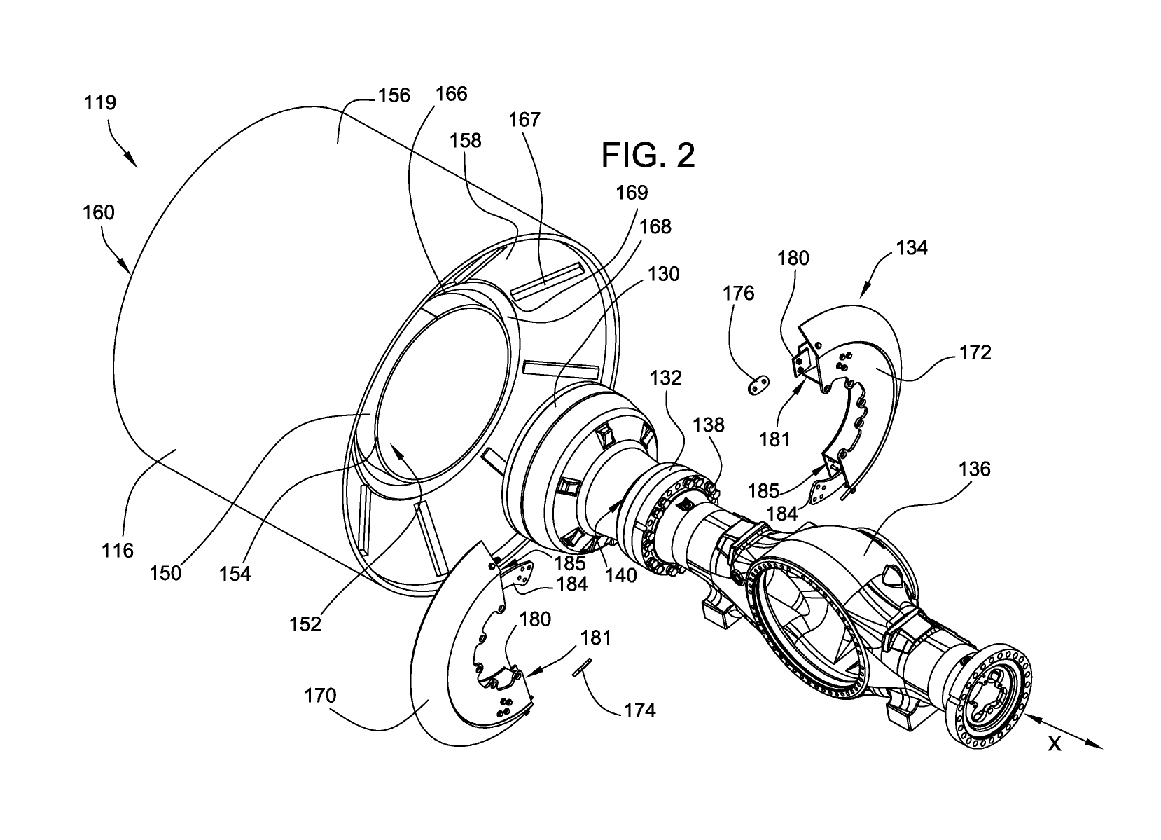

Referring to FIG. 2, a portion of the rear axle assembly 119 is shown. It should be understood that the description of the rear axle 119 is also applicable to the front axle 118. The rear axle assembly includes a wheel 116 (shown in this view without teeth), a distal drive or final drive 130, a spindle 132, and a guard 134 for the left side of the machine; a housing 136; and a spindle, a guard, a final drive, and a wheel for the right side of the machine (not shown). It should be understood that the description of the components of the rear axle 119 for the left side of the machine is applicable to the corresponding components of the rear axle 119 for the right side of the machine.

On each side of the rear axle 119, the spindle 132 is fixedly connected to the housing 136 via a plurality of bolts 138 which are also used to fixedly connect the guard 134 to the housing 136. To allow for the rotation of the wheel, the distal drive 130 is rotatably movable with respect to the spindle 132 which is in fixed relationship to the housing 136. The drive train of the machine can be adapted to be in driving relationship with each final drive 130 of the axles of the machine to provide an all-wheel drive machine. Components of the drive train can be housed within the housing 136, the spindle 132, and the final drive 130.

In the illustrated embodiment, the relative rotation between the final drive 130 and the spindle 132 is accommodated by a sealed interface 140 in the form of a DUO-CONE® seal group assembly of well-known construction and commercially available from Caterpillar Inc. of Peoria, Ill., that helps prevent dirt from entering the axle 119 and retains lubricant within the housing 136, the spindle 132, and the final drive 130. The sealed interface 140 is provided between the distal drive 130 and the spindle 132. The sealed interface 140 in the form of a DUO-CONE® seal is provided along the line of relative rotation and includes sealing surfaces contacting within a plane perpendicular to the axis of rotation “X” of the final drive 130 and the wheel 116 relative to the spindle 132 and the housing 136. For instance, the sealed interface 140 can help contain lubricants for a drive shaft and/or one or more bearings that allow the final drive 130 to rotate smoothly relative to the machine 100. Other seal arrangements are well known to those of skill in the art and can be used in other embodiments.

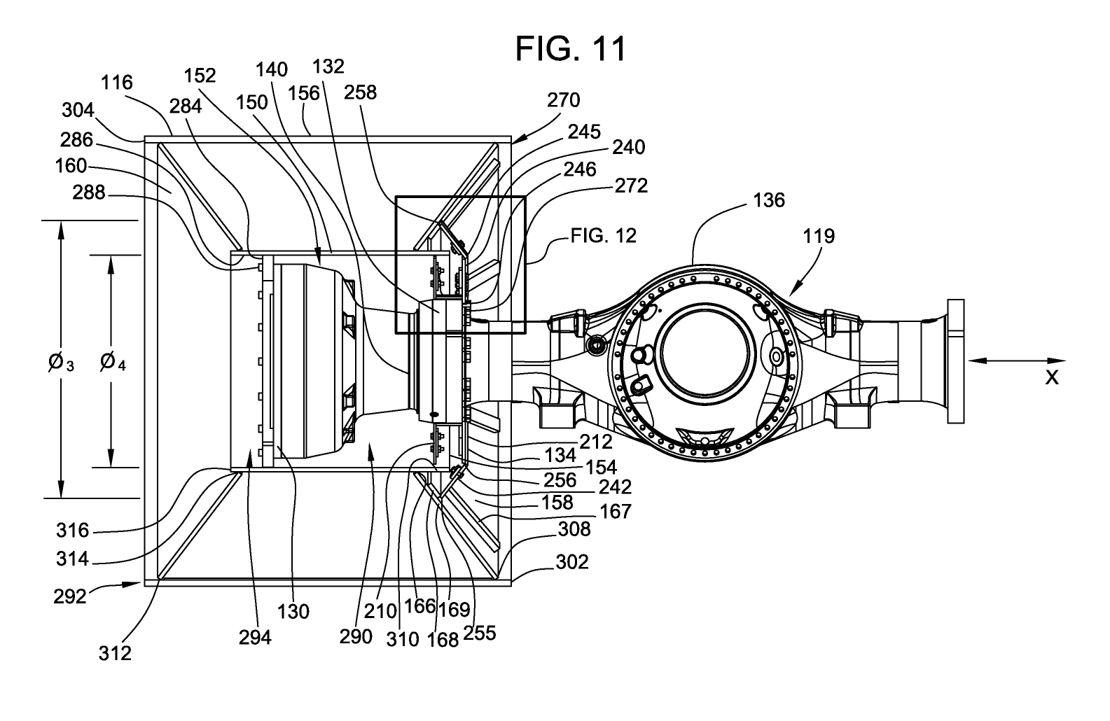

Each wheel 116 of the machine 100 is removably mounted to a respective final drive 130 at both ends of each axle 118, 119 via a plurality of bolts 288 (FIG. 11) in known fashion. Each final drive 130 has a plurality of fastener openings (not shown) disposed peripherally around an outer portion thereof to threadedly engage the bolts (see FIG. 11).

Referring to FIG. 2, the wheel 116 includes a centrally-disposed cylindrical hub 150, which defines a cavity 152 and an inboard opening 154 to the cavity 152, and a cylindrical drum 156 that is positioned substantially concentrically with respect to the hub 150 and the axis “X” of rotation of the axle 119 such that the hub 150 is disposed within the drum 156. In the illustrated embodiment, the drum 156 is substantially wider (along the axis “X” of rotation of the axle) than the hub 150.

Each wheel 116 includes an inner side plate 158 and an outer side plate 160 (see FIGS. 1 and 11) extending between the hub 150 and the drum 156. The drum 156 is connected to the hub 150 by the inner side plate 158 and the outer side plate 160. The inner side plate 158 is substantially frusto-conical and includes a central edge 166 adjacent to the hub 150. The inner side plate 158 is tapered outwardly from the drum 156 to the hub 150. The outer side plate 160 is tapered inwardly from the drum 156 to the hub 150 (see FIGS. 1 and 11). In other embodiments, the inner side plate and the outer side plate can be substantially planar.

Referring to FIG. 2, the inner side plate 158 includes a plurality of wear strips 167 that are in radial, spaced relationship to each other about the axis “X” of rotation of the axle 119. A circumferential flange 168 is disposed radially inwardly from the wear strips 167 and is adjacent the central edge 166. The wear strips 167 and the circumferential flange 168 define a circumferential channel 169 therebetween. The circumferential channel 169 can be adapted to accommodate the guard 134 such that the wheel 116 can rotate relative to the guard 134 and that the guard 134 and the wear strips 167 are in engaging contact.

Referring to FIG. 2, the guard 134 is provided to protect the sealed interface 140 (in this case, a DUO-CONE® seal) associated with the final drive 130 of each of the four wheels 116 from damage from the intrusion of wire wrap into the cavity 152 of each wheel 116. The guard 134 is preferably made from steel plate or steel castings and is generally annular when assembled. The guard 134 includes a pair of guard segments 170, 172 and a pair of connecting links 174, 176. The guard segments 170, 172 can be connected together such that they mate to define an annular structure. Each guard segment 170, 172 includes a wall connector 180 projecting from a wall connector end 181 of the segment 170, 172 and a cover connector 184 projecting from an opposing cover connecter end 185 of the segment 170, 172. Fasteners (not shown) can be provided to secure the projecting portions of the wall connectors 180 and the cover connectors 184 of the respective guard segments 170, 172 to the other guard segment 172, 170 and to secure the connecting links 174, 176 to both guard segments 170, 172. Each connecting link 174, 176 can be secured to a respective opposing wall connector end 181 and cover connector end 185 of both of the guard segments 170, 172 to facilitate the assembly of the guard segments 170, 172 in mating relationship to form the guard 134.

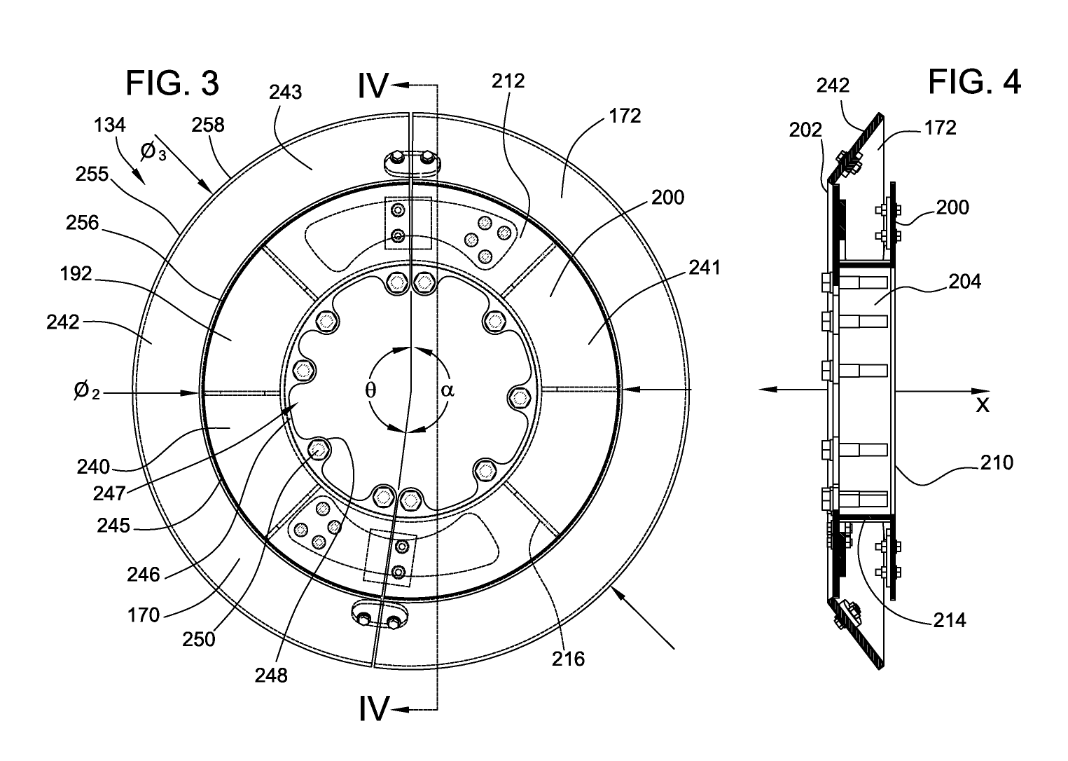

Referring to FIGS. 3-8, the guard 134 for the axle assembly of the machine is shown in its assembled form. Referring to FIG. 3, the illustrated guard 134 includes a minor guard segment 170 and a major guard segment 172, which together form a generally annular structure. The minor guard segment 170 comprises, generally, a sector of an annulus with a central angle θ that is less than 180°. The major guard segment 172 comprises, generally, a sector of an annulus with a central angle α that is greater than 180° and complementary to the central angle θ of the minor guard segment 170 such that the minor guard segment 170 and the major guard segment 172 cooperate together to form a substantially complete annulus.

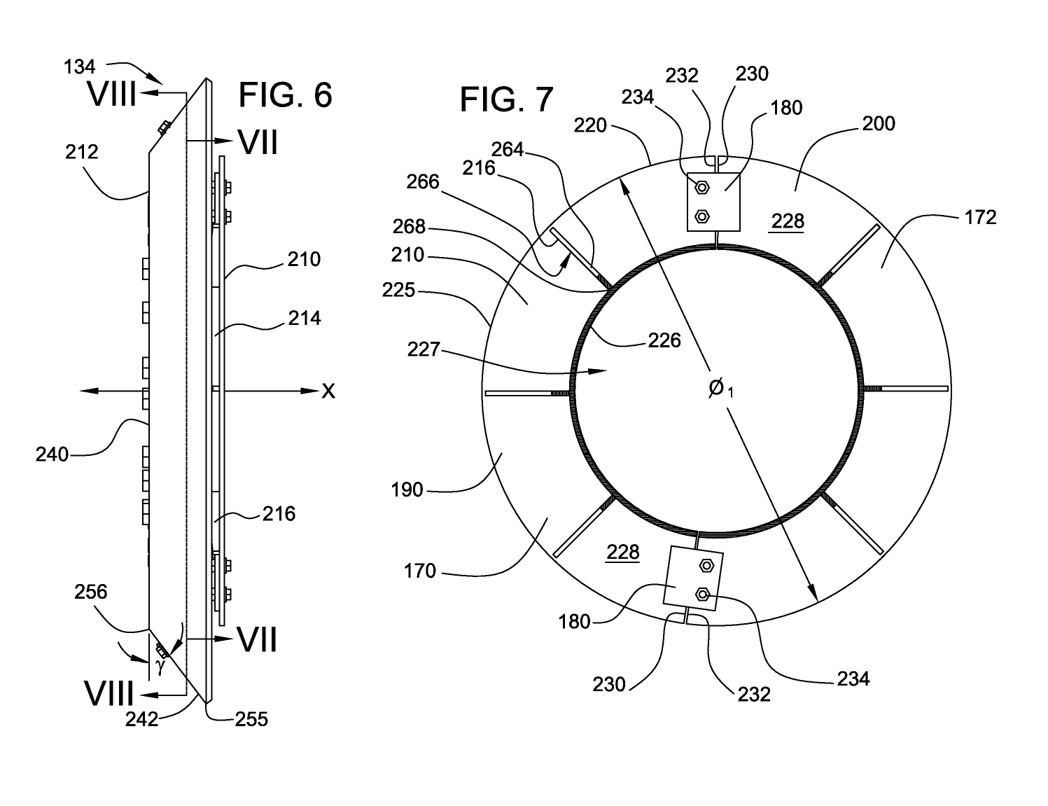

Referring to FIGS. 3-5, the minor guard segment 170 includes a minor wall portion 190 and a minor cover portion 192 disposed in spaced axial relationship along a central axis “X” (see FIGS. 4 and 6) to each other by a minor connecting portion 194. The major guard segment 172 includes a major wall portion 200 and a major cover portion 202 disposed in spaced axial relationship along the central axis “X” to each other by a major connecting portion 204. The components of the minor guard segment 170 and the major guard segment 172 can be connected together by a plurality of weldments (not shown) or can be cast to shape, for example.

Referring to FIGS. 3-6, the assembled guard 134 includes a wall 210 and a cover 212 disposed in spaced axial relationship to the wall 210. A cylindrical connecting member 214 extends axially between the wall 210 and the cover 212. A plurality of support vanes 216 in the form of gussets extends axially between the wall 210 and the cover 212.

Referring to FIG. 6, the wall 210 is substantially planar. Referring to FIG. 7, the wall 210 includes the minor wall portion 190 and the major wall portion 200 and is annular with an outer radial edge 225 and an inner radial edge 226 defining an axle opening 227 adapted to allow an axle to extend therethrough. The outer radial edge 225 defines a circular periphery 220 of the wall 210 having a diameter Ø₁ (FIG. 7) which can be adapted to fit within a cavity of a hub of a ground-engaging device to define a constriction therebetween which helps inhibit the entry of wire wrap into the cavity.

Referring to FIG. 7, the wall connector 180 of both the minor guard segment 170 and the major guard segment 172 is welded to a respective inboard surface 228 of the minor wall portion 190 and the major wall portion 200 such that a portion of the wall connector 180 extends from a connector edge 230 of one guard segment and overlaps a receiving edge 232 of the other guard segment, the connector edge 230 and the receiving edge 232 being opposite one another. A plurality of fasteners 234 can be inserted through mounting holes in each wall connector 180 to secure the wall connector of one guard segment 170, 172 to the other guard segment 172, 170.

Referring to FIGS. 3, 4, and 6, the cover 212 includes the minor cover portion 192 and the major cover portion 202 and is annular. The cover 202 is disposed in spaced axial relationship along the central axis “X” to the wall 210. The cover 212 includes a central portion 240 and a flange 242, which circumscribes the central portion 240.

The central portion 240 of the cover 212 is generally planar, has a planar surface 241, and is substantially parallel to the wall 210. Referring to FIG. 3, the central portion 240 of the cover 212 is annular and has an outer radial edge 245 and an inner radial edge 246 defining an axle opening 247 adapted to allow an axle to extend therethrough. The central portion 240 of the cover 212 includes a plurality of mounting holes 248 disposed in spaced relationship about the inner radial edge 246 and extending radially inwardly therefrom. The mounting holes 248 are adapted to respectively receive a bolt 250 or other fastener therethrough to connect the guard 134 to the axle housing. The outer radial edge 245 of the central portion 240 has a diameter Ø₂ (FIG. 3) which is substantially equal to the diameter Ø₁ (FIG. 7) of the periphery of the wall 210.

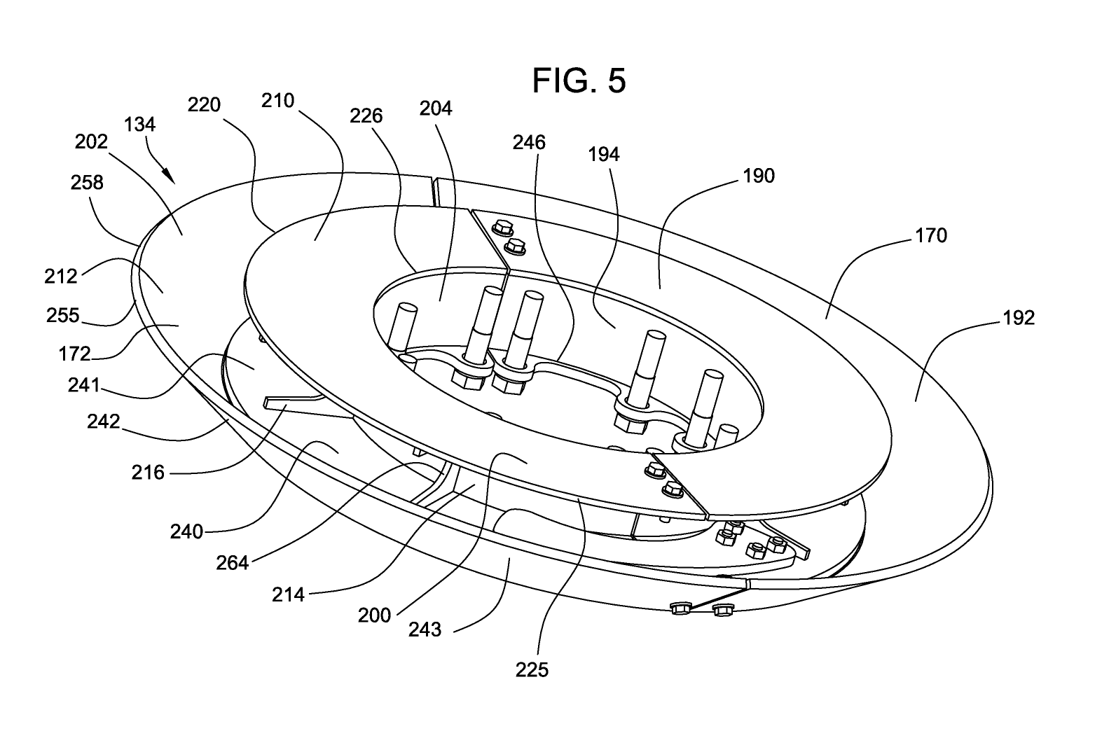

Referring to FIG. 3, the flange 242 comprises a frusto-conical surface 243 and includes an outer radial edge 255 and an inner radial edge 256. The outer radial edge 246 of the central portion 240 adjoins the inner radial edge 256 of the flange 242. The flange 242 extends radially outwardly from its inner radial edge 256 adjacent the central portion 240 to its outer radial edge 255 which defines a periphery 258 of the cover 212 which has a diameter Ø₃ (FIG. 3) that is larger than the diameter Ø₁ (FIG. 7) of the wall 210. Referring to FIG. 5, the periphery 220 of the wall 210 is disposed radially within the periphery 258 of the cover 212 defined by the outer radial edge 255 of the flange 242. Referring to FIG. 6, the flange 242 extends from its inner radial edge 256 outwardly and toward the wall 210 such that, relative to the central axis “X,” the outer radial edge 255 is closer to the wall 210 than the inner radial edge 256 of the flange 242.

In the illustrated embodiment, the outer radial edge 255 of the flange 242 is disposed axially along the central axis “X” between the inner radial edge 256 of the flange 242 and the wall 210. The frusto-conical surface 243 of the flange 242 and the planar surface 241 of the central portion 240 define an angle γ of taper (FIG. 6) which can be adjusted by varying at least one of the axial distance (along the central axis “X”) and the radial distance between the inner radial edge 256 and the outer radial edge 255 of the flange 242. In the illustrated embodiment, the angle γ of taper of the flange 242 is 37.3°. In other embodiments, the flange 242 can have a different angle γ of taper.

In other embodiments, the axial distance along the central axis “X” and/or the radial distance between the inner radial edge 256 and the outer radial edge 255 of the flange 242 can be varied, thereby changing the angle γ of taper between the frusto-conical surface 243 of the flange 242 and the planar surface 241 of the central portion 240. In other embodiments, the angle γ of taper of the flange 242 can be any suitable angle to help define a constriction between the flange 242 and the ground engaging device 116 (FIG. 2) with which the guard is to be used. In still other embodiments, the location of the outer radial edge 255 of the flange 242 can be varied with respect to the position of the wall 210 such that the wall 210 can be disposed axially between the inner radial edge 256 of the flange 242 and the outer radial edge 255 of the flange 242.

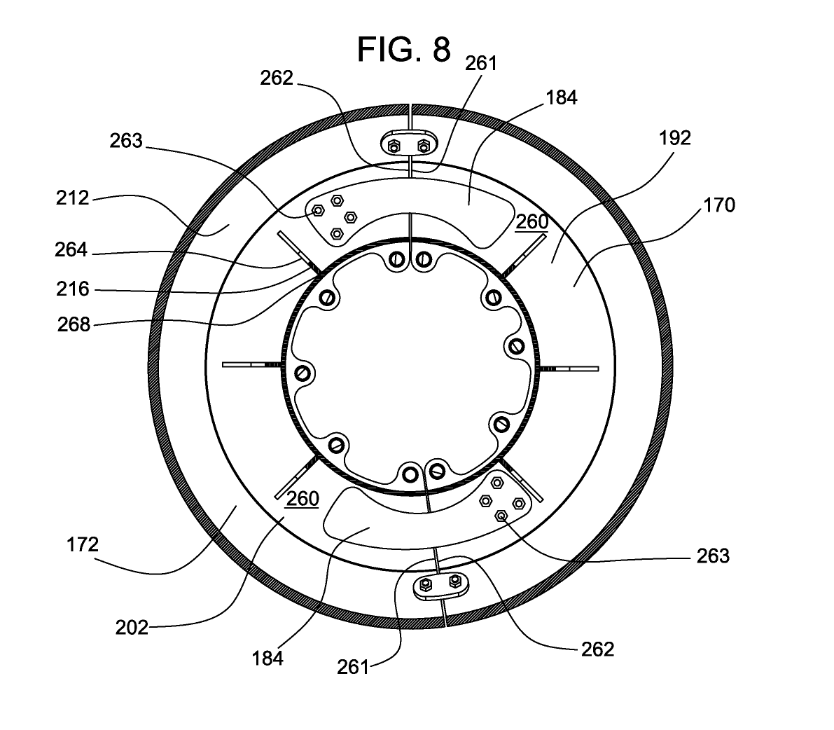

Referring to FIG. 8, the cover connector 184 of both the minor guard segment 170 and the major guard segment 172 is welded to a respective outboard surface 260 of the minor cover portion 192 and the major cover portion 202 such that a portion of the cover connector 184 extends from a cover connector edge 261 of one guard segment and overlaps a receiving edge 262 of the other guard segment, the cover connector edge 261 and the receiving edge 262 being opposite one another. A plurality of fasteners 263 can be inserted through mounting holes in each cover connector 184 to secure the cover connector 184 of one guard segment 170, 172 to the other guard segment 172, 170.

Referring to FIG. 5, the connecting member 214 is substantially cylindrical. The connecting member 214 includes the minor connecting portion 194 and the major connecting portion 204. The connecting member 214 substantially conforms to the size of the inner radial edge 226 of the wall 210 and of the inner radial edge 246 of the central portion 240 of the cover 212. The height of the connecting member 214 along the central axis “X” of the guard 134 can be varied to change the axial distance between the central portion 240 of the cover 212 and the wall 210.

Referring to FIGS. 3, 5, 7, and 8, the support vanes 216 are disposed in spaced relationship to each other about the central axis “X” of the guard 134. The support vanes 216 extend between the wall 210 and the central portion 240 of the cover 212. The support vanes 216 can provide support for the wall 210 and the cover 212. Each support vane 216 can be connected to both the cover 212 and the wall 210 (e.g., by weldments) to enhance the structural rigidity of the guard 134. In the illustrated embodiment, six support vanes 216 are provided. In other embodiments, the number of support vanes, their form (e.g., gussets) and the spacing therebetween can be varied (e.g., eight gussets).

The support vanes 216 can also serve as a spool to help guide wire wrap that may infiltrate the cover 212 of the guard 134 such that the infiltrated wire wrap winds around the support vanes 216, thereby further helping to prevent entry into an inner wheel cavity through the constricted gap between the inner wire wall and the interior of the wheel cavity. Referring to FIGS. 5, 7, and 8, each support vane 216 in the form of a gusset includes an outer concave edge 264 to help define a spool surface upon which wire wrap can be wound and which is in radial offset relationship to the connecting member 214 to facilitate the removal of any wire wrap that infiltrates the guard 134.

Referring to FIG. 7, each support vane 216 includes a planar vane surface 266 extending substantially radially with respect to the axis “X” of rotation of the axle. Referring to FIGS. 7 and 8, each support vane 216 includes a radial inner edge 268 which is disposed adjacent the central opening 227 of the wall 210 and the cover 212 (see FIG. 8). The vane surfaces 266 are substantially perpendicular to the wall 210 and the central portion 240 of the cover 212.

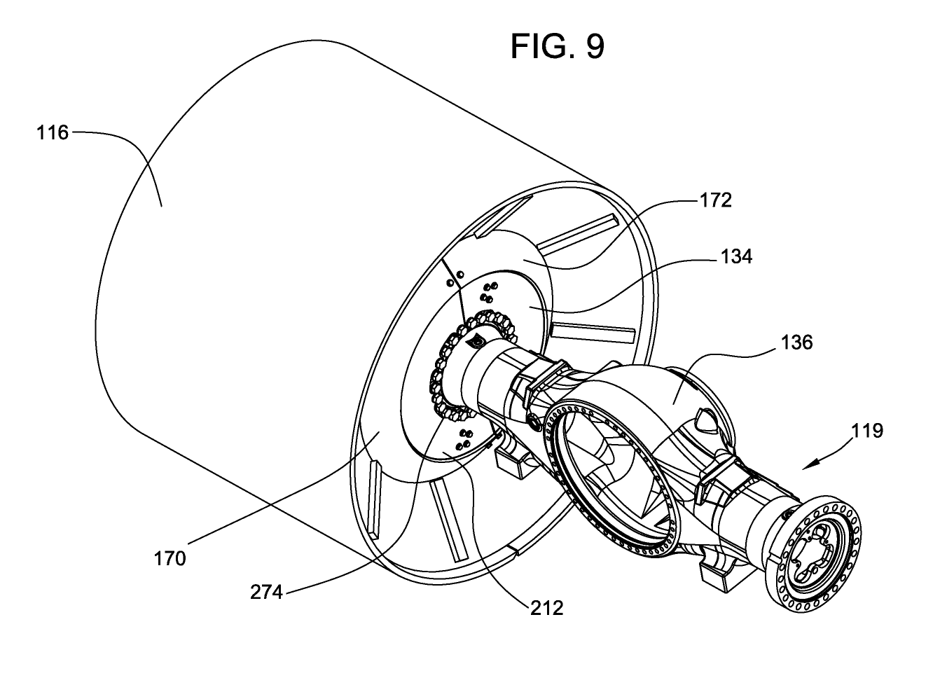

Referring to FIGS. 9-12, the components of the rear axle 119 for the left side of the machine and the housing 136 are shown in an assembled position. The wheel 116 is rotatably mounted to the axle 119.

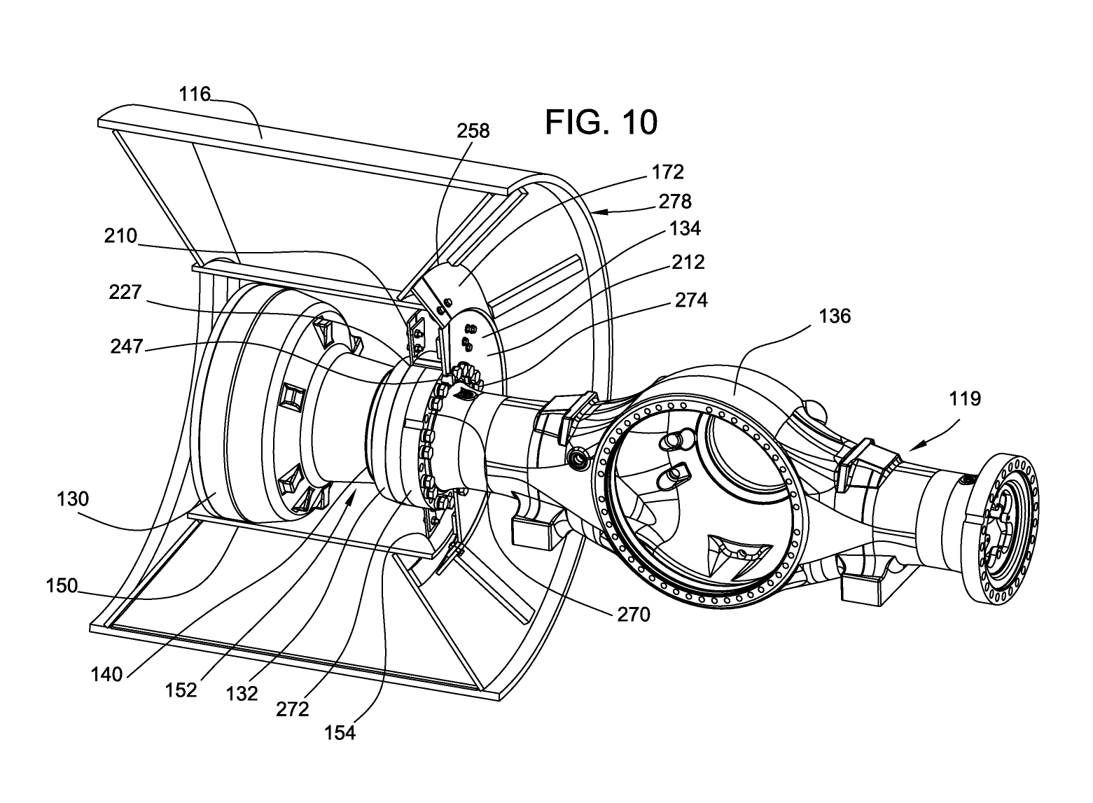

Referring to FIGS. 9 and 10, the guard 134 is mounted to the axle 119. The guard 134 can be mounted to the axle 119 such that the ground engaging device, in this case, in the form of a wheel 116, is rotatable with respect to the guard 134. In the illustrated embodiment, the cover 212 is fixedly connected to an inboard side 270 of a mounting flange 272 (see FIG. 10) on the axle housing 136 with a plurality of fasteners 274.

The cover 212 occludes the inboard opening 154 to the cavity 152 of the hub 150, thereby inhibiting the entry of wire wrap. The periphery 258 of the cover 212 is radially larger than the inboard opening 154 to the cavity 152 of the hub 150 (see FIG. 10).

The segmented design of the guard 134 can facilitate the mounting of the guard 134 to the axle 119. Each guard segment 170, 172 can be separately connected to the mounting flange 272 of the axle housing 136. The guard 134 can be connected to the mounting flange 272 with the same fasteners 274 that connect the spindle 132 to the housing 136. The respective overlapping connecting links, wall connectors, and cover connectors of one guard segment 170, 172 can be fastened to the other guard segment 172, 170 once the guard segments 170, 172 are brought together to encircle the components of the left side of the axle 119 extending through the axle opening 227 of the wall 210 and the axle opening 247 of the cover 212. When the guard 134 is mounted to the mounting flange 272, the axle housing 136 extends through the axle opening 247 of the cover 212, and the spindle 132 extends through the axle opening 227 of the wall 210.

Referring to FIG. 10, a portion of the axle 119 extends axially outwardly through the inboard opening 154 of the cavity 152 of the wheel 116 such that the sealed interface 140 of the axle 119 is disposed within the cavity 152 of the wheel 116. The distal drive 130 is connected to the hub 150 through conventional means.

The wall 210 of the guard 134 is disposed within the cavity 152 of the hub 150 of the wheel 116. The wall 210 of the guard 134 is disposed axially inwardly of the sealed interface 140 to help prevent wire wrap from reaching the sealed interface 140 from an inboard side 278 of the wheel 116.

Referring to FIG. 11, a hub flange 284 extends peripherally along an inner surface 286 of the hub 150 into the cavity 152. The hub flange 284 is substantially perpendicular to the axis “X” of rotation of the axle 119. The hub flange 284 has a plurality of fastener openings circumferentially disposed thereabout and adapted to receive fasteners 288 therethrough to connect the wheel 116 to the final drive 130 of the axle 119.

The hub flange 284 and the inboard opening 154 define the axial limits of an inboard portion 290 of the cavity 152. The inboard portion 290 of the cavity 152 is disposed closer to the inboard side 270 of the wheel 116 (which is closer to the machine when the wheel 116 is mounted than an outboard side 292 thereof) than the remainder 294 of the cavity 152. The hub flange 284 and the final drive 130 cooperate together to substantially prevent the entry of wire wrap into the inboard portion 290 of the cavity 152 from the outboard side 292 of the wheel 116.

The drum 156 has an inboard edge surface 302 and an outboard edge surface 304 with respect to the mounting orientation of the wheel 116 in relation to the machine 100, as shown in FIG. 1. The hub 150 is concentrically positioned within the drum 156.

The frusto-conical inner side plate 158 extends from an outer edge 308 adjacent the inboard edge surface 302 of the drum 156 to its central edge 166, which is adjacent the hub 150 such that an extension portion 310 of the hub 150 extends axially inwardly a predetermined distance (e.g., 100 millimeters) from the central edge 166 of the inner side plate 158 toward the cover 212 of the guard 134 to the inboard opening 154 of the cavity 152. The inboard opening 154 to the cavity 152 is disposed axially outwardly from the inboard edge surface 302 of the wheel 116 such that the extension portion 310 of the hub is disposed axially within the frusto-conical inner side plate 158.

The frusto-conical outer side plate 160 has a shape which is substantially the minor image of the inner side plate 158. The frusto-conical outer side plate 160 extends from an outer edge 312 adjacent the outboard edge surface 304 of the drum 156 to a central edge 314 adjacent an outboard opening 316 of the hub 150.

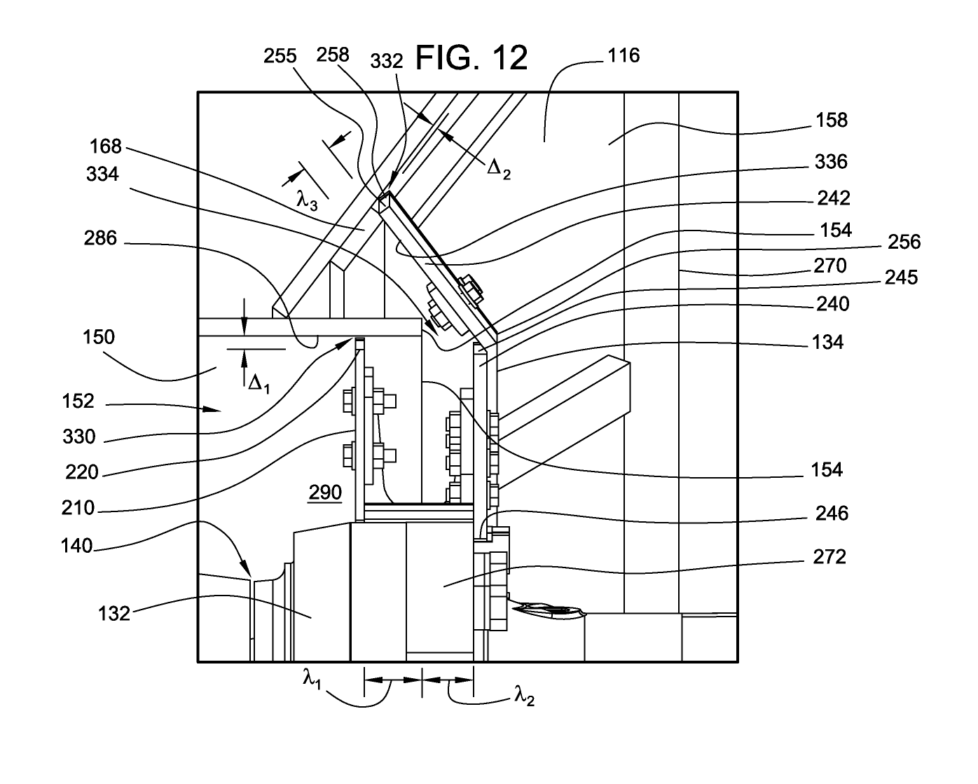

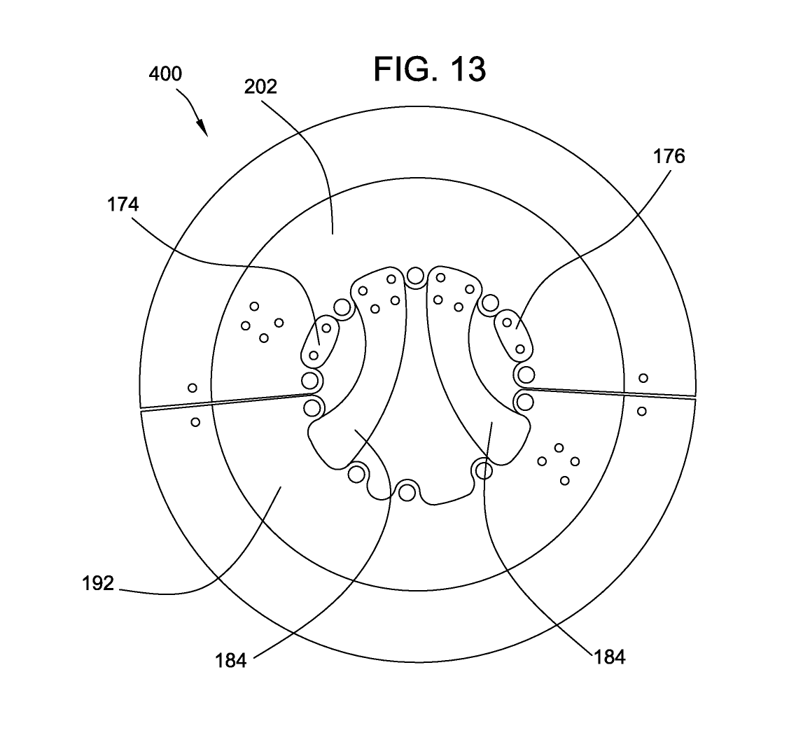

The wall 210 substantially occludes the annular cross-sectional opening defined between the spindle 132 and the hub 150 at the axial location of the wall 210 with a radial tolerance gap Δ₁ to define a constriction therebetween (see FIG. 12). The wall 210 of the guard 134 is axially disposed within the extension portion 310 of the hub 150 within the cavity 152.

The cover 212 can act as a deflector or canopy to help prevent the entry of wire wrap from entering the inboard opening 154 to the cavity 152 from the inboard side 270 of the wheel 116. The central portion 240 of the cover 212 is disposed axially inwardly of the inboard opening 154 to the cavity 152 of the hub 150. The outer radial edge 245 of the central portion 240 of the cover 212 is substantially radially aligned with the hub 150. The inner radial edge 246 of the central portion 240 of the cover 212 is in overlapping radial position with respect to the mounting flange 272 of the axle housing 136 such that the central portion 240 of the cover 212 substantially radially occludes the annular cross-sectional opening defined by the spindle 132 and the inboard opening 154 to the cavity 152 of the hub 150.

The inner radial edge 256 of the flange 242 of the cover 212 is substantially radially aligned with the hub 150. The flange 242 extends radially outwardly from the inner radial edge 256 to the outer radial edge 255 such that the periphery 258 of the flange 242 has a diameter Ø₃ that is greater than the diameter Ø₄ of the hub 150. The outer radial edge 255 of the flange 242 is disposed axially outwardly relative to the inboard opening 154 to the cavity 152 of the hub 150 such that the inboard opening 154 is disposed axially between the inner radial edge 256 and the outer radial edge 255 of the flange 242.

The outer radial edge 255 of the flange 242 is disposed within the circumferential channel 169 of the inner side plate 158 disposed between the circumferential flange 168 and the wear strips 167. The circumferential flange 168 of the inner side plate 158 cooperates with the flange 242 of the cover 212 to help seal the periphery 258 of the guard 134, thereby helping to inhibit the entry of wire wrap into the cavity 152 of the wheel 116. The flange 242 of the cover 212 and the circumferential flange 168 of the inner side plate 158 can have an interference fit to help provide a positive seal therebetween.

Referring to FIG. 12, the periphery 220 of the wall 210 of the guard 134 and the inner surface 286 of the hub 150 define a constriction 330 therebetween which is adapted to inhibit the entry of wire wrap into the inboard portion 290 of the cavity 152 housing the sealed interface 140. In the embodiment shown, the periphery 220 of the wall 210 is at a clearance distance Δ₁ along a radial direction from the inner surface 286 of the hub 150. The wall 210 is disposed a predetermined distance λ₁ axially outwardly from the inboard opening 154 to the cavity 152. In some embodiments, the constriction 330 can have a clearance distance Δ₁ which provides the desired impedance to the entry of wire wrap into the cavity 152 of the hub 150 (e.g., a clearance distance of about two millimeters or less). In other embodiments, the clearance distance Δ₁ can be different (e.g., to accommodate aggregated tolerances for various piece parts to facilitate assembly).

The periphery 258 of the flange 242 of the guard 134 cooperates with the inner side plate 158 to define a constriction 332 therebetween which is adapted to inhibit the entry of wire wrap into the inboard portion 290 of the cavity 152 through the inboard opening 154. In the embodiment shown, the periphery 258 of the flange 242 is at a clearance distance Δ₂ along a direction substantially perpendicular to the frusto-conical surface of the inner side plate 158. In some embodiments, the constriction 332 can have a clearance distance Δ₂ which provides the desired impedance to the passage of wire wrap through the constriction 332 between the periphery 258 of the flange 242 of the guard 134 and the inner side plate 158 (e.g., a clearance distance of about 1.5 mm or less). In other embodiments, the clearance distance Δ₂ can be different (e.g., to accommodate aggregated tolerances for various piece parts to facilitate assembly).

The flange 242 is in engaging contact with the circumferential flange 168 of the inner side plate 158 of the wheel 116 to substantially seal the guard 134 and the wheel 116. The circumferential flange 168 substantially occludes the constriction 332 between the flange 242 and the inner side plate 158.

The flange 242 substantially occludes an axial gap 334 defined between the central portion 240 of the cover 212 and the inboard opening 154 to the cavity 152 of the hub 150. In the embodiment shown, the axial gap 334 has an axial length λ₂ that is approximately the same as the distance λ₁ the wall 210 is disposed outwardly from the inboard opening 154 to the cavity 152. The flange 242 is disposed a predetermined distance λ₃ from the inboard opening 154 to the cavity 152, where the distance is measured along an axis substantially perpendicular to an outboard surface 336 of the flange 242.

In the embodiment shown, the constriction 332 between the flange 242 and the inner side plate 158 is disposed axially outwardly relative to the axial gap 334 defined between the central portion 240 of the cover 212 and the inboard opening 154 to the cavity 152. This axial outward offset can augment the function of the guard 134 by introducing an additional obstacle to the intrusion of wire wrap or other debris. In order for wire wrap to enter the cavity 152 of the hub 150 from the inboard side 270 of the wheel 116, the wire wrap must travel a generally “S”-shaped path that includes traveling axially outward to pass through the constriction 332 between the flange 242 and the inner side plate 158, reversing course and traveling axially inward to extend through the axial gap 334 defined between the central portion 240 of the cover 212 and the inboard opening 154 to the cavity 152, and then resuming an axial outward path to force its way through the constriction 330 defined between the periphery 220 of the wall 210 of the guard 134 and the inner surface 286 of the hub 150.

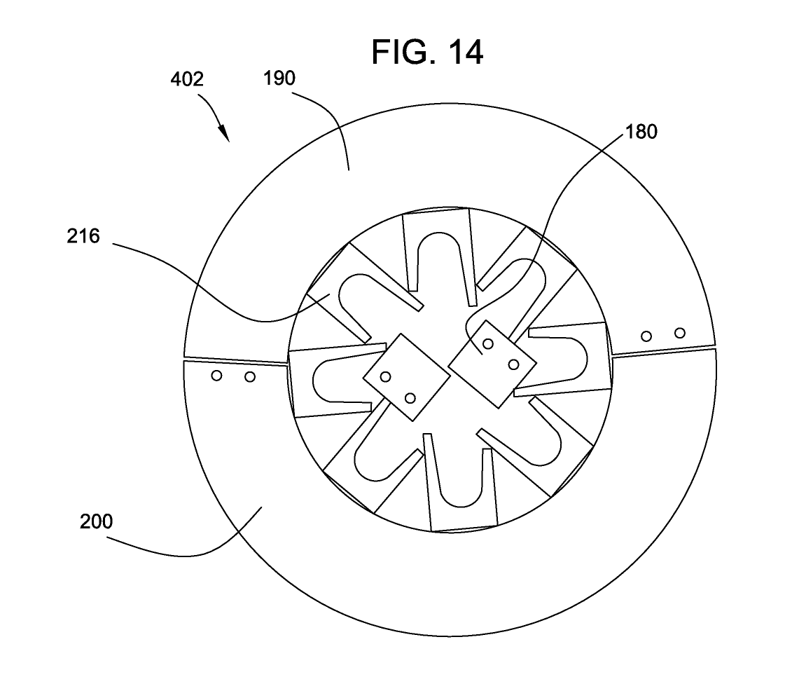

FIGS. 13 and 14 respectively show first and second cutting plans 400, 402 for first and second sets of component of the guard 134 (FIG. 5). The first cutting plan 400 and the second cutting plan 402 can be used to layout components of the guard on stock sheet metal in an efficient manner.

Referring to FIG. 13, the first cutting plan 400 includes a first set of components comprising the minor cover portion 192, the major cover portion 202, the pair of connecting links 174, 176, and the pair of cover connectors 184. The first cutting plan 400 can be used to cut the first set of components from metal sheet stock that is a suitable thickness, such as a 12 mm thick steel circular blank, for example.

Referring to FIG. 14, the second cutting plan 402 includes a second set of components comprising the minor wall portion 190, the major wall portion 200, eight support vanes 216 in the form of gussets, and the pair of wall connectors 180. The second cutting plan 402 can be used to cut the second set of components from metal sheet stock that is a suitable thickness, such as an 8 mm thick steel circular blank, for example. The minor and major connecting portions of the guard can be made from strip material stock of any suitable material including steel.

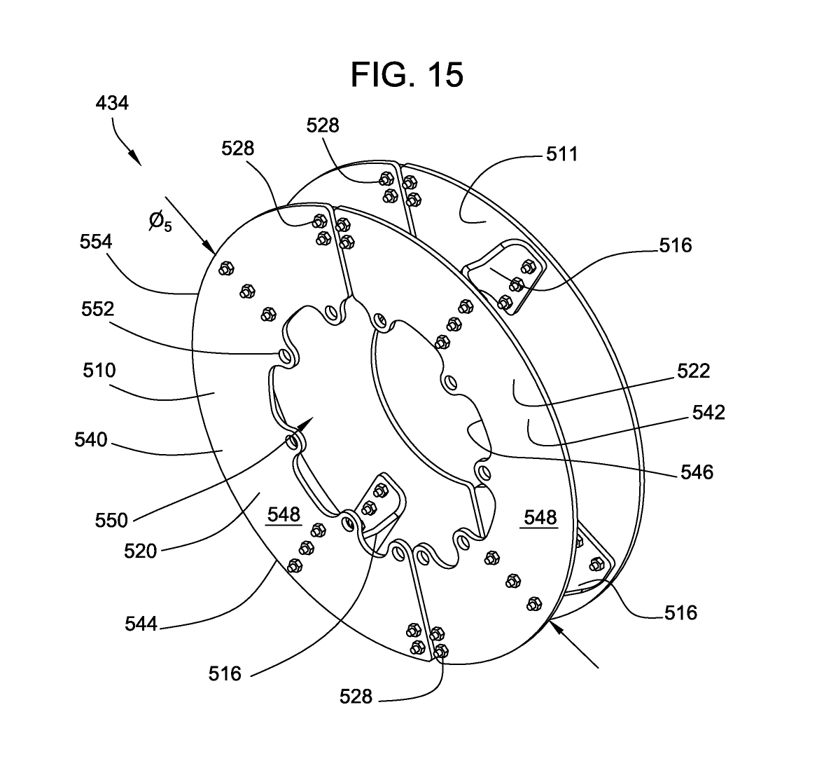

Referring to FIGS. 15-18, another embodiment of a guard 434 for an axle assembly of a machine is shown. The guard 434 includes a first wall 510, a second wall 511, and a plurality of support vanes 516. The guard 434 can have a segmented construction similar to the guard 134 of FIG. 3.

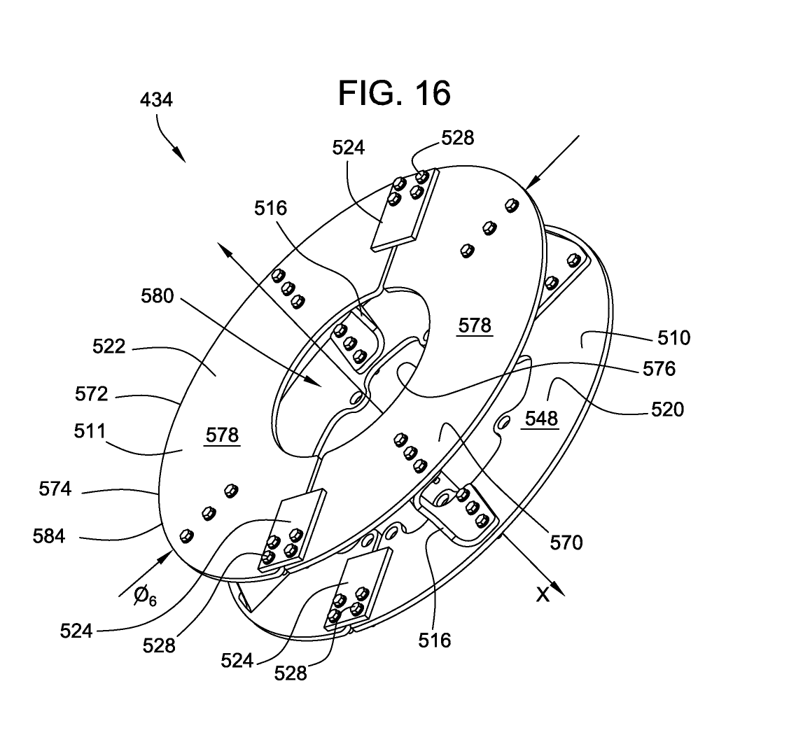

Referring to FIGS. 15 and 16, in this embodiment, the guard 434 includes a pair of guard segments 520, 522 that are substantially the same and a plurality of connecting plates 524. In the illustrated embodiment, four connecting plates 524 are provided. The guard segments 520, 522 can be connected together via the connecting plates 524 such that they mate to define an annular structure. Fasteners 528 can be provided to secure each connecting plate 524 to both guard segments 520, 522 such that the guard segments 520, 522 are in mating relationship to form the guard 434.

Referring to FIG. 15, the first wall 510 includes a pair of first wall portions 540, 542 and is annular with an outer radial edge 544 and an inner radial edge 546 defining a planar wall surface 548 therebetween.

The inner radial edge 546 defines a central axle opening 550 adapted to allow an axle to extend therethrough. A plurality of mounting holes 552 are disposed around the central opening 550 and are adapted to allow the guard 434 to be mounted to a component of an axle assembly (such as a mounting flange of an axle housing, for example) such that the guard 434 is in fixed relationship with respect to the axle and a wheel mounted to the axle is rotatable with respect to the guard.

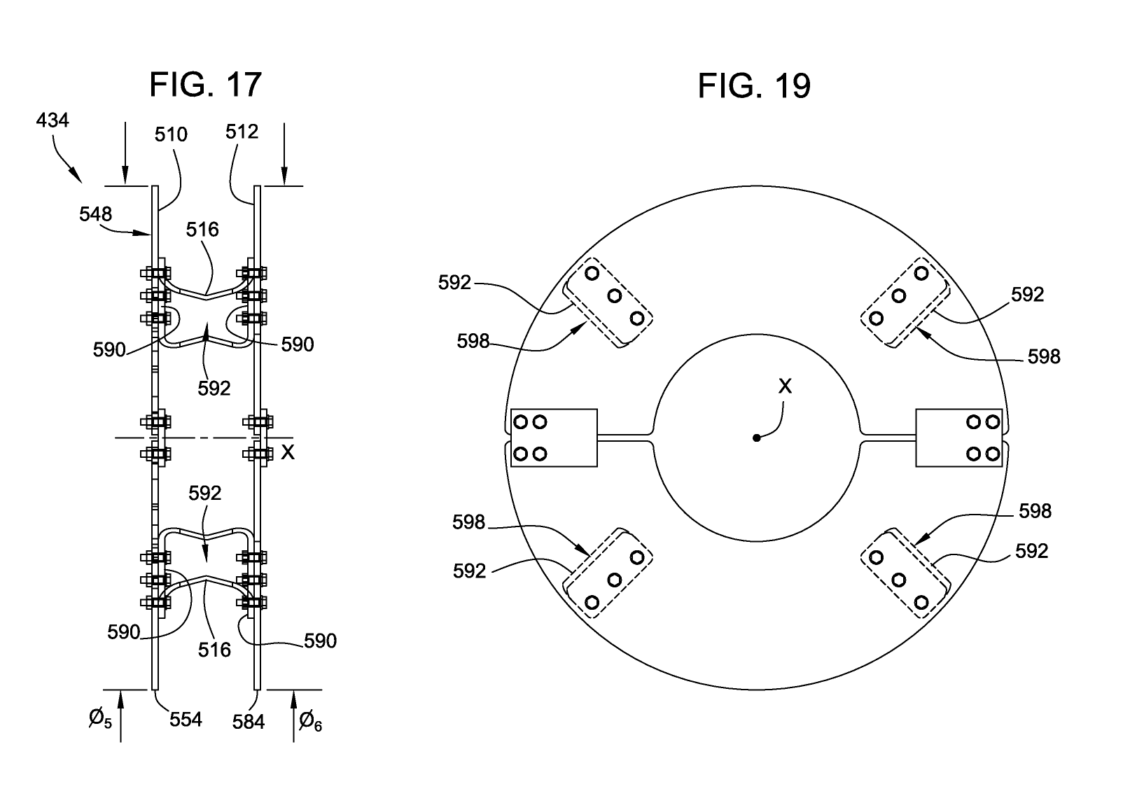

The outer radial edge 544 defines a circular periphery 554 of the first wall 510 with a circumference of a predetermined diameter Ø₅ (see FIG. 17 also). The size of the periphery 554 of the first wall 510 can be adapted to fit within a cavity of a hub of a ground-engaging device to define a constriction therebetween which helps inhibit the entry of wire wrap into the cavity.

Referring to FIG. 16, the second wall 511 includes a pair of second wall portions 570, 572 and is annular with an outer radial edge 574 and an inner radial edge 576 defining a planar wall surface 578 therebetween.

The inner radial edge 576 defines a central axle opening 580 adapted to allow a portion of an axle to extend therethrough. The outer radial edge 574 defines a circular periphery 584 of the second wall 511 with a circumference of a predetermined diameter Ø₆ (see FIG. 17 also). The size of the periphery 584 of the second wall 511 can be adapted to fit within a cavity of a hub of a ground-engaging device to define a constriction therebetween which helps inhibit the entry of wire wrap into the cavity.

The diameter Ø₆ of the circular periphery 584 of the second wall 511 is substantially the same as the diameter Ø₅ of the circular periphery 554 of the first wall 510. The central axle openings 550, 580 can both be adapted to closely conform to a predetermined portion of an axle assembly, and the portions of the axle assembly can have different shapes. In the illustrated embodiment, for example, the central axle opening 580 of the second wall 211 is smaller than the central axle opening 550 of the first wall.

Referring to FIG. 17, the second wall 511 is disposed in spaced relationship to the first wall 510 along a longitudinal axis “X” substantially perpendicular to the planar wall surfaces 548, 578 of the first wall 510 and the second wall 511. The second wall 511 is arranged such that the periphery 584 of the second wall 511 is substantially concentrically aligned with the periphery 544 of the first wall 510, respectively (see FIGS. 15 and 16 also). The support vanes 516 extend between the first wall 510 and the second wall 511 and connect the first wall 510 to the second wall 511.

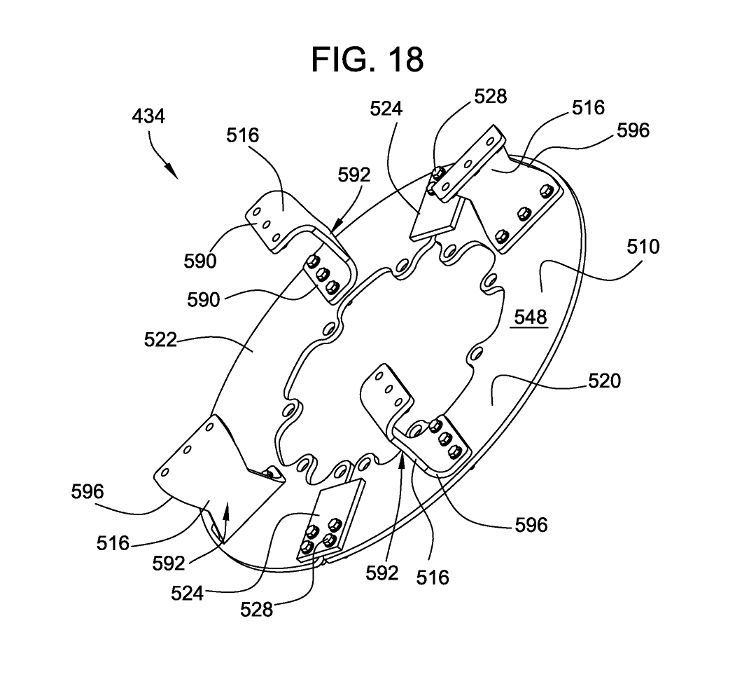

Referring to FIG. 18, in the illustrated embodiment, four support vanes 516 are provided which are in approximately equal spaced circumferential relationship to each other about the first wall 510 and the second wall. Each support vane 516 has a generally U-shaped cross-section with each guard segment 520, 522 having a pair of support vanes 516 in facing relationship to each other. In other embodiments, the number of support vanes can be varied.

Referring to FIGS. 17 and 18, each support vane 516 includes a pair of distal mounting flanges 590 and an axially extending support wall 592 therebetween. The support vanes 516 extend between the first wall 510 and the second wall 511 such that a respective mounting flange 590 is in contacting relationship with the first wall 510 and the second wall 511.

Referring to FIGS. 17-19, the support wall 592 of each support vane 516 includes a planar vane surface 598 extending substantially radially to the longitudinal axis “X”. Each support vane surface 598 is substantially perpendicular to the planar wall surfaces 548, 578 of the first wall 510 and the second wall 511.

Each support vane 516 includes a radial outer edge 596 which is disposed adjacent the peripheries 554, 584 of the first wall 510 and the second wall 511. The radial outer edge 596 of each support vane 516 is concave, in the form of a V-shape, and together the radial outer edges 596 can define a spool surface upon which wire wrap that infiltrates the guard 434 can be wound for ready removal therefrom.

In some embodiments, the guard 434 can be mounted to an axle assembly such that the first wall 510 which includes the mounting holes 552 is disposed such that the first wall 510 is inboard of the second wall 511 with respect to the machine to which the guard is mounted. In this arrangement, the second wall 511 and the first wall 510 of the guard can be disposed within a cavity of a hub of a ground engaging device (such as a wheel, for example) such that the first wall 510 is disposed axially inwardly of the second wall 511. The first wall 510 and the second wall 511 can cooperate with the hub to define therebetween a first constriction and a second constriction, respectively, which help inhibit the entry of wire wrap into the cavity. The first wall 510 and the second wall 511 can both be disposed axially inwardly of a sealed interface (such as a DUO-CONE® seal) housed within the cavity with the second wall 511 disposed between the sealed interface and the first wall 510.

In other embodiments, the guard 434 can be mounted to an axle assembly such that the first wall 510, which includes the mounting holes 552, is outboard of the second wall 511 with respect to the machine to which the guard is mounted. In this arrangement, the second wall 511 and the first wall 510 of the guard can be disposed within a cavity of a hub of a ground engaging device (such as a wheel, for example) such that the first wall 510 is disposed axially outwardly of the second wall 511. The second wall 511 and the first wall 510 can cooperate with the hub to define therebetween a first constriction and a second constriction, respectively, which help inhibit the entry of wire wrap into the cavity. The first wall 510 and the second wall 511 can both be disposed axially inwardly of a sealed interface (such as a DUO-CONE® seal) housed within the cavity with the first wall 510 disposed between the sealed interface and the second wall 511.

### INDUSTRIAL APPLICABILITY

The described principles are applicable to machines having a transmission to link a power source to the final ground-engaging device, e.g., wheels, tracks, etc., and/or to another powered function or implement. Examples of such machines include compaction machines, including a landfill compactor, for example.

The industrial applicability of the embodiments of a guard for an axle assembly of a landfill compaction machine described herein will be readily appreciated from the foregoing discussion. Intrusion of wire wrap and/or other landfill material into a central cavity of a hub of a ground-engaging device, such as a wheel, can be detrimental to the function, reliability, and serviceability of the sealed interface disposed within the cavity. The embodiments of a guard discussed herein can help prevent intrusion of such wire wrap or other debris into the central cavity of a wheel. The tortuous path defined by the various cooperating components disposed along an access path that the wire wrap would follow to penetrate the cavity can effectively impede intrusion of debris into the wheel cavity.

The present disclosure is applicable to barrier arrangements for sealed interfaces between wheels and axles of landfill compaction machines. The guards disclosed herein can advantageously be offered on new equipment, or can be used to retrofit existing equipment operating in the field.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A guard for an axle assembly of a machine comprising:
a wall including a periphery; and
a cover disposed in spaced axial relationship to the wall, the cover including a central portion and a flange, the flange circumscribing the central portion and extending radially outwardly therefrom and axially toward the wall, and the flange including an outer edge defining a periphery of the cover;
wherein the periphery of the wall is disposed radially within the periphery of the cover.

2. The guard according to claim 1, wherein the wall is annular, the periphery of the wall has a first diameter, the outer edge of the flange is circular, the periphery of the cover has a second diameter, and the second diameter is larger than the first diameter.

3. The guard according to claim 2, wherein the central portion of the cover is generally planar and is substantially parallel to the wall.

4. The guard according to claim 3, wherein the central portion of the cover is annular and has an outer edge, having a third diameter, the third diameter being substantially equal to the first diameter.

5. The guard according to claim 1, wherein the flange comprises a frusto-conical surface.

6. The guard according to claim 1, wherein the central portion of the cover includes at least one mounting hole.

7. The guard according to claim 1, further comprising:
a connecting member axially extending between the wall and the cover.

8. The guard according to claim 1, further comprising:
a plurality of gussets axially extending between the wall and the cover, each gusset including an outer concave edge.

9. A guard for an axle assembly of a machine comprising:
a first wall including a planar wall surface;
a second wall including a planar wall surface, the second wall disposed in spaced relationship to the first wall along a longitudinal axis substantially perpendicular to the planar wall surface of both the first wall and the second wall; and
a support vane extending between the first wall and the second wall, the support vane including a planar vane surface extending substantially radially to the longitudinal axis.

10. The guard according to claim 9, wherein the first wall includes a circumference having a first diameter, the second wall includes a circumference having a second diameter, and the first diameter and the second diameter are substantially the same.

11. The guard according to claim 9, wherein the first wall includes a central opening, and the second wall includes a central opening.

12. The guard according to claim 11, wherein the first wall includes a plurality of mounting holes disposed around the central opening.

13. The guard according to claim 11, wherein the support vane includes a radial inner edge which is disposed adjacent the central opening of both the first wall and the second wall.

14. The guard according to claim 9, wherein the first wall includes a periphery, the second wall includes a periphery, and the support vane includes a radial outer edge which is disposed adjacent the periphery of both the first wall and the second wall.

15. The guard according to claim 9, wherein the planar vane surface is substantially perpendicular to the planar wall surface of both the first wall and the second wall.

16. A machine comprising:
a frame;
a ground engaging device including a hub defining a cavity and an inboard opening to the cavity;
an axle connected to the frame and supporting the ground engaging device; and
a guard mounted to the axle, the guard including:
a wall including a periphery, the wall disposed within the cavity of the ground engaging device, and
a cover disposed in spaced axial relationship to the wall, the cover including a central portion and a flange circumscribing the central portion, the central portion disposed axially inwardly of the inboard opening to the cavity, the flange extending radially outwardly from the central portion and axially outwardly toward the wall, the flange including an outer edge defining a periphery of the cover, and
wherein the periphery of the wall is disposed radially within the periphery of the cover, and the periphery of the cover is larger than the opening to the cavity.

17. The machine according to claim 16, wherein the ground engaging device includes a drum and an inner side plate extending between the hub and the drum, the outer edge of the flange cooperating with the inner side plate to define a constriction.

18. The machine according to claim 17, wherein the inner side plate includes a circumferential flange disposed radially inwardly of the outer edge of the flange and adapted to substantially occlude the constriction between the outer edge of the flange and the inner side plate.

19. The machine according to claim 17, wherein the wall of the guard and the hub define a second constriction.

20. The machine according to claim 19, wherein the inner side plate is substantially frusto-conical and includes a central edge adjacent to the hub, and the hub includes a portion axially extending a predetermined distance toward the cover of the guard from the central edge of the inner side plate.
